(19) United States
(12) Patent Application Publication
(10) Pub. No.: US 2011/0168035 A1
(43) Pub. Date: Jul. 14, 2011

(54) Carving station assembly

(75) Inventors: Joseph Jeremy Saunders, Sturgeon Bay, WI (US); John Quella, Sturgeon Bay, WI (US)

(73) Assignee: Hatco Corporation

(21) Appl. No.: 12/804,182

(22) Filed: Jul. 15, 2010

Related U.S. Application Data
(60) Provisional application No. 61/270,962, filed on Jul. 15, 2009.

(51) Int. Cl. A47J 47/00

(52) U.S. Cl. 99/537

(57) ABSTRACT

A carving station assembly having an adjustable lamp assembly, wherein the assembly is adjustable by way of a telescoping post arm, an adjustment knob, and pivotal lamp head.

### RELATED APPLICATIONS

This application claims the benefit of U.S. provisional patent application Ser. No. 61/270,962 filed 15 Jul. 2009.

### BACKGROUND OF THE INVENTION

The present invention is directed to an improved food carving station assembly, and particularly to a carving station in which the heating lamp height is adjustable by way of a telescoping arm, an adjustment knob, and a pivotal lamp assembly.

### SUMMARY OF THE INVENTION

Carving stations are designed to allow all types of meats and roasts for human consumption to be kept warm for carving and serving, therefore typical carving stations are designed to maintain hot food at a serving temperature, while providing an appropriate environment for the carving process. Devices such as these are typically found in commercial settings, such as restaurant buffets, in which a food service operator familiar with the device, slices or otherwise dispenses the food product to the consumer.

A typical carving station assembly keeps the food to be served warm by way of a heated cutting board and lamp assembly, or alternatively, solely by way of a lamp assembly. In known assemblies, the lamp assembly may have either static lamp arms, or have a flexible gooseneck design. However, the static lamp arm provides only limited use of the lamp, and does not allow for the lamp to be moved to accommodate a change in location of the roast, or the height changed to accommodate a desired reduction or increase in the amount of heat provided to the roast, or any other reason that makes a flexible arm advantageous. The gooseneck design, while providing the desired motion, has many grooves along the neck which can collect food, dust, and other particles and items which may compromise the cleanliness and the sanitation of the carving station. The present invention overcomes these shortcomings by including the unique features of a telescoping lamp arm that is smooth and continuous, and a swivel lamp head to provide positional adjustment of the lamp assembly.

### BRIEF DESCRIPTION OF THE DRAWINGS

FIG. 1 is a perspective view of a carving station according to the present invention.

FIG. 2 is a front view of a carving station according to the present invention.

FIG. 3 is a top view of a carving station according to the present invention.

FIG. 4 is a perspective view of a carving station according to the present invention with arrows indicating the relative movement of the component parts.

FIG. 5A is a cross-sectional view of the telescoping post assembly of the present invention.

FIG. 5B is an enlarged cross-sectional view of the adjustment knob and adjustment accessory shown in FIG. 5A.

FIG. 6 is a perspective view of the adjustment knob of the present invention.

FIG. 7 is a side view of an embodiment of a carving station according to the present invention.

FIG. 8 is a perspective view of the carving station shown in FIG. 7.

FIG. 9 is a perspective view of an embodiment of a carving station according to the present invention, particularly showing a single post assembly and a single lamp assembly.

FIG. 10 is a perspective view of an embodiment of a carving station according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

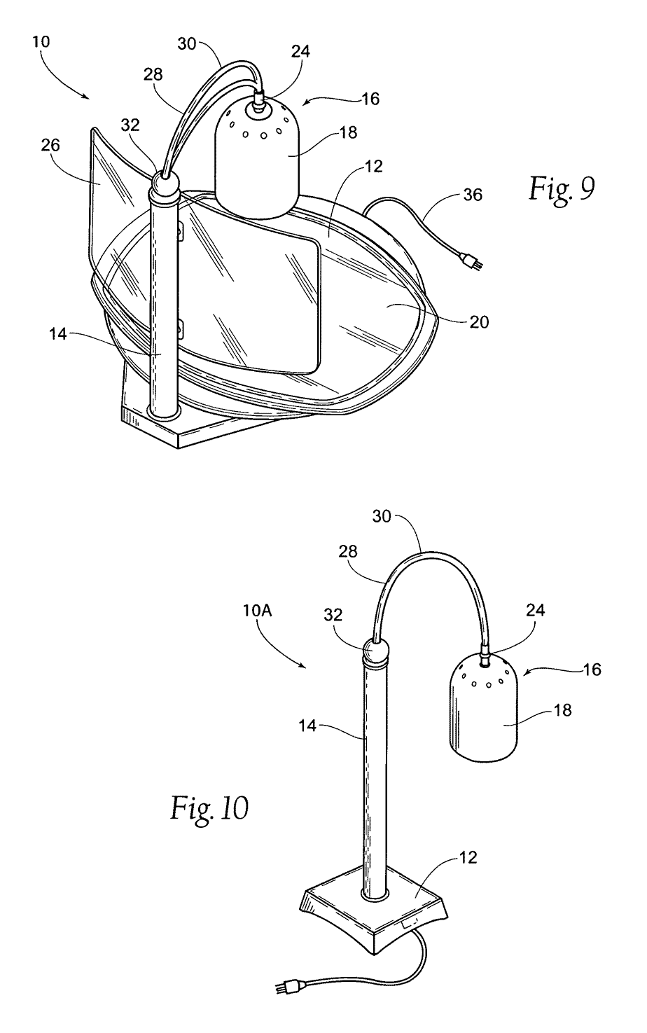

As may be seen in the Figures, a carving station 10 according to the present invention preferably includes a base member 12, at least one telescoping post assembly 14, and at least one lamp assembly 16, including a lamp shade 18. The base member 12, as shown, is preferably substantially rectangular in shape, but may be any shape that can accommodate carving, serving, and warming meat, roasts, or other hot foods. The base 12 includes a cutting board 20, which may be heated and which may be removable for cleaning. The cutting board 20 may also include an au jus channel 22 for capturing food juices released during carving. Optionally, the cutting board 20 may not be heated, with heat being solely provided by the lamp assembly 16. The carving station 10 may include a breath protector 26. The breath protector 26 is attached to at least one telescoping post assembly 14 and provides a barrier between the foods on the cutting board and the individual being served. The breath protector 26 may be made of glass, plastic, or any other rigid, transparent material, and may be flat or curved as desired, the curved option shown particularly in FIG. 9. The assembly includes an AC power cord and plug 36 to provide power to the lamps 16 and, optionally, the heated cutting board 20.

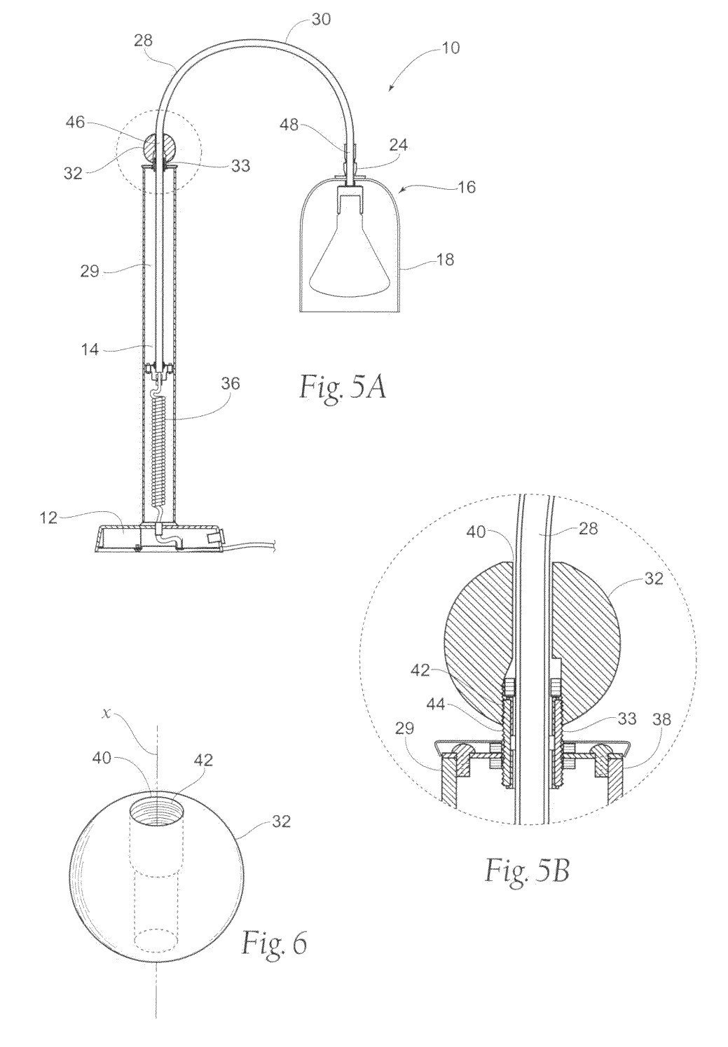

Preferably, the height of the lamp assembly 16 is adjustable by way of the telescoping post assembly 14. The telescoping post assembly is shown in detail in FIGS. 5A and 5B. As seen, a post assembly 14 preferably includes a pair of longitudinally coextending members including a first post member 28 that is vertically moveable and a second post member 29 that is stationary. The post members 28, 29 are preferably adapted to telescope such that the first post 28 fits into the second post 29. Further, the telescoping assembly 14 may preferably include means for adjustment, such as the adjustment knob 32 and adjustment accessory 33 shown, which are adapted to allow for adjustment of the lamp assembly 16 height, and then to retain the lamp assembly 16 in place after the desired height position is obtained. FIG. 4 illustrates the telescoping assembly 14 in an extended position, achieving a higher lamp height, with arrows A indicating relative movement of the post member 28. As may be further seen, arrows B indicate relative movement of lamp assembly 16.

Referring to FIGS. 5A and 5B, the adjustment knob 32 may be seen coupled adjacent an end 38 of the stationary second post member 29 and around the first post member 28. As further seen in FIG. 6, the knob 32 has a cylindrical opening 40 through which the first post member 28 passes. Screw threads 42 encircle the cylindrical opening 40, at least partially through the length of the cylindrical opening 40. The screw threads 42 are compatible with a second set of screw threads 44 on an adjustment accessory 33.

As shown particularly in FIG. 5B, the adjustment accessory 33 may be coupled directly to an end 38 the stationary second post member 29 and positioned around the first post member 28. In use, the adjustment knob 32 may be rotated in a first direction whereby the two sets of compatible screw threads 42, 44 interlace. When the adjustment knob 32 is rotated in a second, opposite direction, the two sets of compatible screw threads 42, 44 disengage. As the threads 42, 44 become disengaged, the adjustment accessory 33 loosens from around the first post member 28 and allows for vertical movement of the first post member 28 from the stationary second post member 29, to allow for height adjustment. At the desired height, the adjustment knob 32 is rotated in the opposite direction, interlacing the two sets of threads 42, 44, tightening the adjustment accessory 33 and maintaining the position of the first post member 28 at the desired height.

A carving station 10 according to the present invention preferably includes at least a base member 12, a telescoping post assembly 14 extending from the base member 12. The post assembly 14 comprising a pair of longitudinally coextending post members 28, 29, wherein the pair of post members includes a first post member 28 and a second, stationary post member 29. The first post member 28 includes a proximal end 46 and a distal end 48, with the proximal end 46 at least partially inserted into and configured to move vertically within the second post member 29. The carving station further preferably includes the aforementioned height adjustment knob 32, the height adjustment knob 32 includes an axis X (see FIG. 6) with a cylindrical opening 40 extending through the axis X. The adjustment accessory 33 may be seen to be coupled to a proximal end 38 of the second post member 29, with the adjustment accessory 33 extending upwardly around the proximal end 46 of the first post member 28. The knob 32 preferably includes means for coupling to the adjustment accessory 33. A lamp assembly 16 is coupled to the distal end 48 of the first post member. A preferred lamp assembly 16 includes a swivel assembly 24 and a lamp shade 18, although it is to be understood that a lamp shade is not required to practice the present invention.

As shown in FIG. 5A, the telescoping post assembly 14 may also include, within the second post member 29, a power supply cord 36 to provide power to the lamp assembly 16. In one configuration, the cord 36 is maintained in a coiled configuration within the second post member 29, so that it may extend and contract in accordance with the vertical movement of the first post member 28.

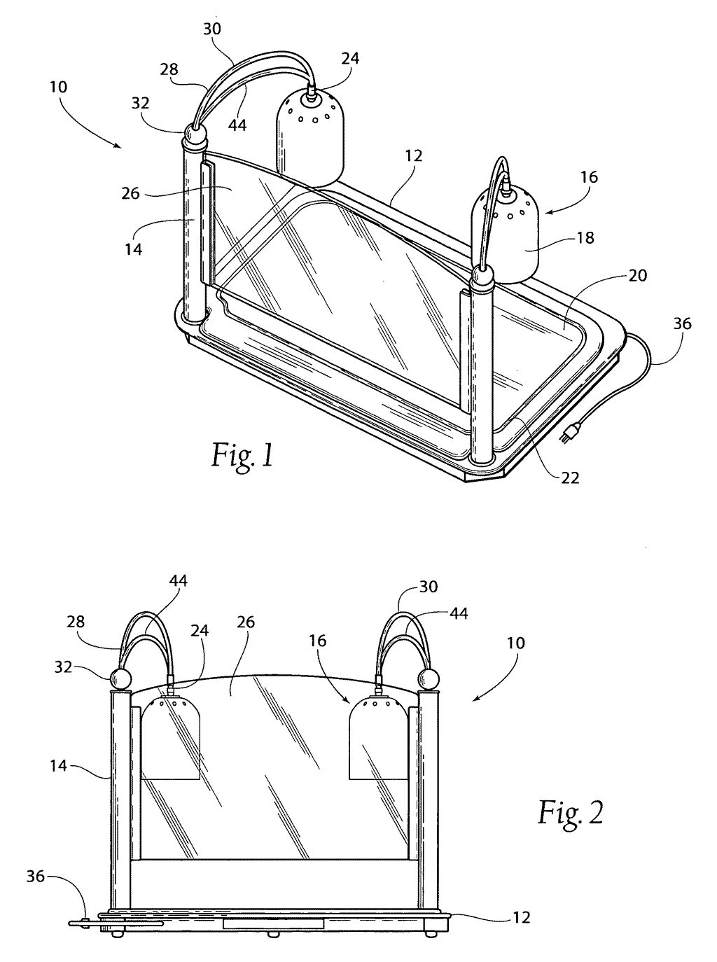

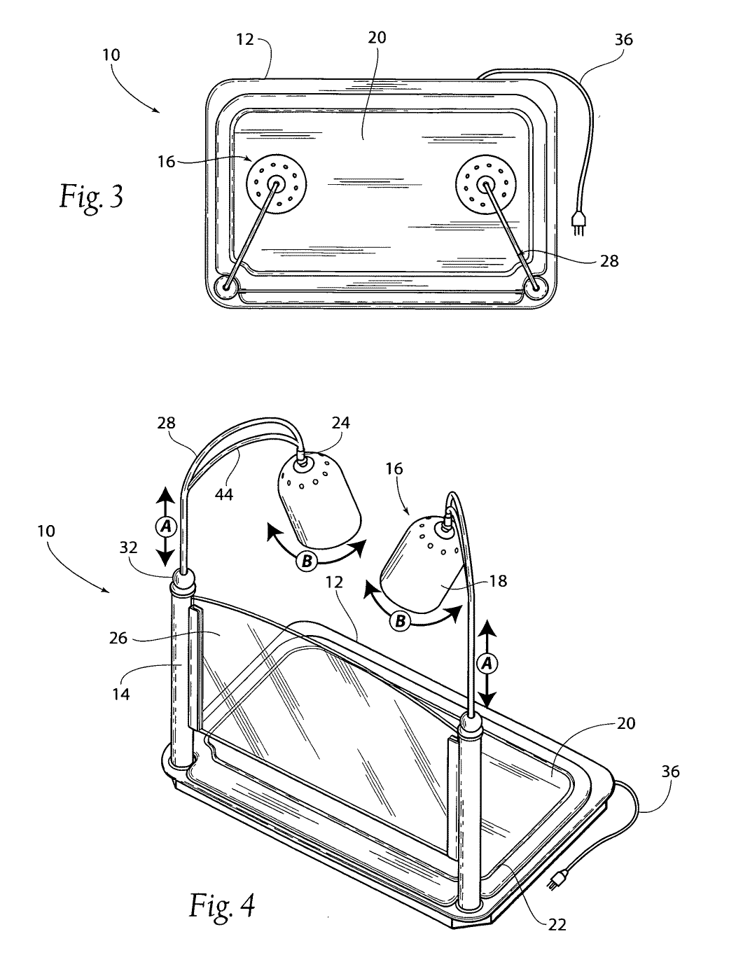

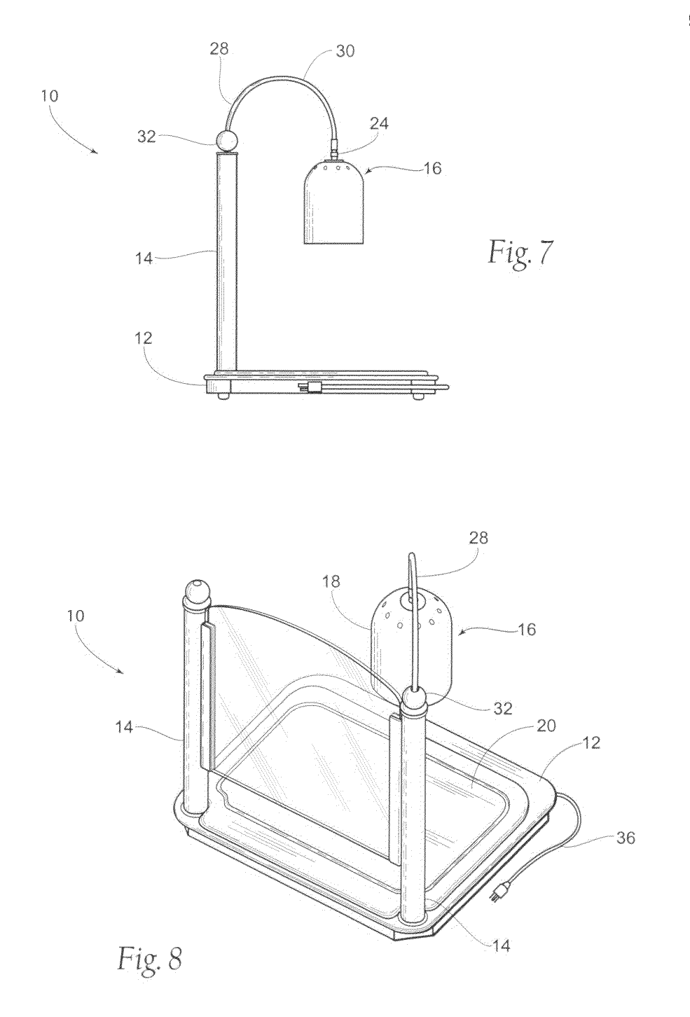

As illustrated the post assembly 14 is preferably secured to a base member 12 at a position convenient for illumination of the cutting board 20 during use. As may be further seen, the first post member 28 may include a curved portion 30 which terminates in a swivel connector assembly 24. FIGS. 1-4 depict a second curved member 44 coupled between the first member 28 and the swivel assembly 24 for additional support, but it is to be understood that the invention may be practiced without second support arm 44, as is shown in FIG. 7. The swivel assembly 24 is adapted to support and position a lamp assembly 16 for illuminating the cutting board 20 or other work surface. Arrows B in FIG. 4 indicate pivotal movement of the lamp assembly 16 to alter the focus of the light source. The lamp assembly 16 may include any acceptable light source, such as a standard heat bulb (not shown) and preferably includes a lamp shade 18 for directing the light source.

As viewed in the figures, it is to be understood that a carving station 10 according to the present invention may include any number of post assemblies 14, and lamp assemblies 16. By way of non-limiting example, FIGS. 1-4 depict a carving station 10 having a plurality of post assemblies 14, each having a lamp assembly 16. As shown in FIG. 8, the present invention may include a plurality of post assemblies 14, but a single lamp assembly 16. As further seen in FIGS. 9 and 10, the present invention may also include a single post assembly 14 and single lamp assembly 16.

As may be further viewed, with reference to FIG. 10, a carving station 10A according to the present invention may include a base member 12, telescoping post assembly 14, swivel connector assembly 24 and lamp assembly 16, without the need for the attached cutting board 20 shown in other Figures. In this embodiment, a work surface, such as a cutting board (not shown) may be supplied as a separate element. It is to be understood that the lamp adjustment accessory, comprising the post assembly 14 and the adjustment knob 32 may be used in conjunction with any of the embodiments contemplated.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

We claim:

1. A carving station comprising:
a base member;
a telescoping post assembly extending from said base member, said post assembly comprising a pair of longitudinally coextending post members, said pair of post members including a first post member and a second, stationary post member, said first post member having a proximal end and a distal end, said proximal end at least partially inserted into and configured to move vertically within said second post member;
a height adjustment knob, said height adjustment knob having an axis and a cylindrical opening extending through said axis;
an adjustment accessory coupled to a proximal end of said second post member, said adjustment accessory extending upwardly around said proximal end of said first post member;
said knob having means for coupling to said adjustment accessory; and
a lamp assembly coupled to said distal end of said first post member, said lamp assembly including a swivel assembly and a lamp shade.

2. The carving station of claim 1 wherein said means for coupling said knob to said adjustment accessory includes threads encircling at least a longitudinal portion of said cylindrical opening and wherein said adjustment accessory includes compatible threads configured for association with said threads on said height adjustment knob.

3. The carving station of claim 2 wherein said threads are configured to loosen about said first post member as said threads on said adjustment accessory and said adjustment knob are disengaged when moved in a first direction, and tighten about said first post member as said threads interlace when moved in a second direction.

4. The carving station of claim 1 wherein said base member further comprises a cutting board.

5. The carving station of claim 1 further comprising a breath protector coupled to said telescoping post assembly.

6. The carving station of claim 1 comprising a plurality of telescoping post assemblies.

7. The carving station of claim 6 comprising a plurality of lamp assemblies.

8. The carving station of claim 4 wherein said cutting board is heated.

9. The carving station of claim 4 wherein said cutting board is removable.

10. The carving station of claim 4 wherein said base further includes a channel to collect liquids on said cutting board.
